(19) United States
(12) Patent Application Publication
(10) Pub. No.: US 2012/0330728 A1
(43) Pub. Date: Dec. 27, 2012

(54) DYNAMIC BUSINESS PERFORMANCE TAGGING AND MONITORING

(75) Inventors: David M. Enyeart, Raleigh, NC (US); Richard D. Johnson, Raleigh, NC (US); Eric D. Wayne, Raleigh, NC (US)

(73) Assignee: International Business Machines Corporation, Armonk, NY (US)

(21) Appl. No.: 13/168,458

(22) Filed: Jun. 24, 2011

(51) Int. Cl. G06Q 10/00

(52) U.S. Cl. 705/7.39

(57) ABSTRACT

A business performance tagging module system and its operations are described herein. In some embodiments, the operations can include detecting an event associated with business-related content and evaluating the business-related content against a plurality of tags associated with a plurality of key performance indicators responsive to said detecting the event associated with the business-related content. The operations can further include determining that a set of the plurality of tags corresponds to the business-related content based, at least in part, on said evaluating the business-related content against the plurality of tags, and selecting a set of the plurality of key performance indicators associated with the set of the plurality of tags. The operations can further include presenting computational representations of the set of the plurality of key performance indicators via a user interface responsive to said selecting the set of the plurality of key performance indicators.

### BACKGROUND

Embodiments of the inventive subject matter relate generally to systems that track business performance indicators.

Business situations can be evaluated using key performance indicator (KPIs). KPIs indicate the health of a business and the areas in which action should be taken. Individuals employed by a business need to respond to changing business needs instantaneously, including requiring access to the right KPIs at the right moment.

### SUMMARY

In some embodiments, operations can include detecting an event associated with business-related content and evaluating the business-related content against a plurality of tags associated with a plurality of key performance indicators responsive to said detecting the event associated with the business-related content. The operations can further include determining that a set of the plurality of tags corresponds to the business-related content based, at least in part, on said evaluating the business-related content against the plurality of tags, and selecting a set of the plurality of key performance indicators associated with the set of the plurality of tags. The operations can further include presenting computational representations of the set of the plurality of key performance indicators via a user interface responsive to said selecting the set of the plurality of key performance indicators.

### BRIEF DESCRIPTION OF THE DRAWINGS

The present embodiments may be better understood, and numerous objects, features, and advantages made apparent to those skilled in the art by referencing the accompanying drawings.

FIG. 1 is an illustration of an example business performance management system 100.

FIG. 2 is a flowchart depicting example operations for assigning and suggesting tags related to KPIs.

FIG. 3 is an illustration of an example business performance management system 300.

FIG. 4 is a flowchart depicting example operations for presenting KPIs based on tag analysis.

FIG. 5 is a flowchart depicting example operations for presenting KPI tags according to relevance.

FIG. 6 depicts an example computer system 600.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to key performance indicators (KPIs), other instances may include other indicators of performance measurement such as performance metrics, critical success factors, goal targets, technical performance measures, figures of merit, some combinations therefore, etc., in applied information economics, corporate strategy, performance-based logistics, military management, device performance, etc. In other instances, well-known instruction instances, protocols, structures and techniques have not been shown in detail in order not to obfuscate the description.

Typically, KPIs are presented to users using a dashboard page generated by, and controlled via, a business performance application or software product. The dashboard page usually contains a list of KPIs. The list of KPIs, however, may or may not be relevant to a business situation. A user that is interested in KPIs that are relevant to the business situation manually selects or searches for the relevant KPIs. Manually selecting or searching fails to present relevant KPIs in dynamic ways that adjust to a business situation.

Embodiments of the inventive subject matter detect information related to a current business situation and dynamically adjust presentation of KPIs for business information that is current (e.g., in real-time). For example, a business performance tool that implements the inventive subject matter can detect descriptive information (e.g., data or metadata) associated with content that is presented via a dashboard interface, compare the information to tags assigned to descriptions of KPIs, and present computational representations of some of the KPIs that have tags equivalent to the descriptive information. The business performance tool can also determine degrees of relevance for tags and presents tags in a way that visually depicts the degrees of relevance. The example business performance tool can pre-configure KPI descriptions with user-selected tags and suggest, or assign, additional tags based on analysis of semantics and components of the user-selected tags. The dynamic adjustment, or updating, of KPIs can be specific to a user's role, or function, within a business organization.

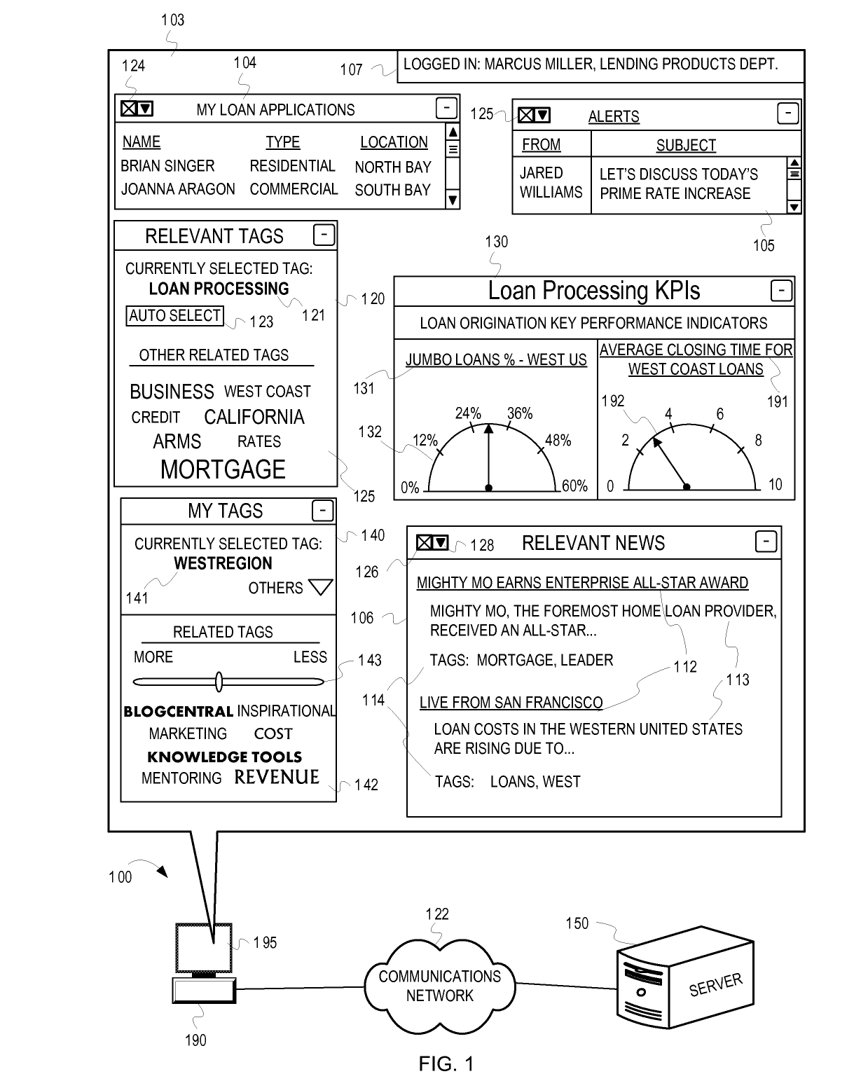

FIG. 1 is an illustration of an example business performance management system 100. In FIG. 1, the business performance management system (“system”) 100 includes one or more devices that are connected to each other, such as a computer 190 and a server 150 that are connected by a communications network 122. The computer 190 is configured to receive user input via various input capturing devices, such as a keyboard, a mouse, a microphone, etc. The computer 190 includes a display 195. The display 195 presents a user interface (“interface”) 103. The interface 103 is configured to present various information related to a business (“business-related information”), such as information from business forms and processes, events that occur within the business structure or that are related to the business, news about the business, etc.

The system 100 detects a situation (e.g., an event) associated with business-related content. Business-related information characterizes the business-related content associated with the situation. For example the system 100 detects that the interface 103 presents business-related content via the interface 103. Specifically, in one example, the system 100 detects information from a loan application form that a user selects, is working in, has worked on, etc., as indicated in the loan application section 104. In another example, the system 100 detects business alerts (e.g., from an alerts section 105), which indicate a variety of information about the business, such as changes to product pricing, rates, inventory, etc. In another example, the system 100 detects organizational information related to a logged-in user, such as the user's department in the business organization or a user's role (e.g. manager, executive, etc.). The system 100 may present the business-related content based on the user's role in the business organization. For example, the interface 103 can be configured, by direct user input, by templates, by administrative user input, etc., to present content that is specific to the user's role within the organization. In yet another example, the system 100 detects news content presented within a news feed 106. The news content indicates information (e.g., text articles, videos, etc.) that are pertinent to the business. The news content includes, for example, titles 112 of news articles, summaries 113 of news articles, and tags 114 associated with the news articles.

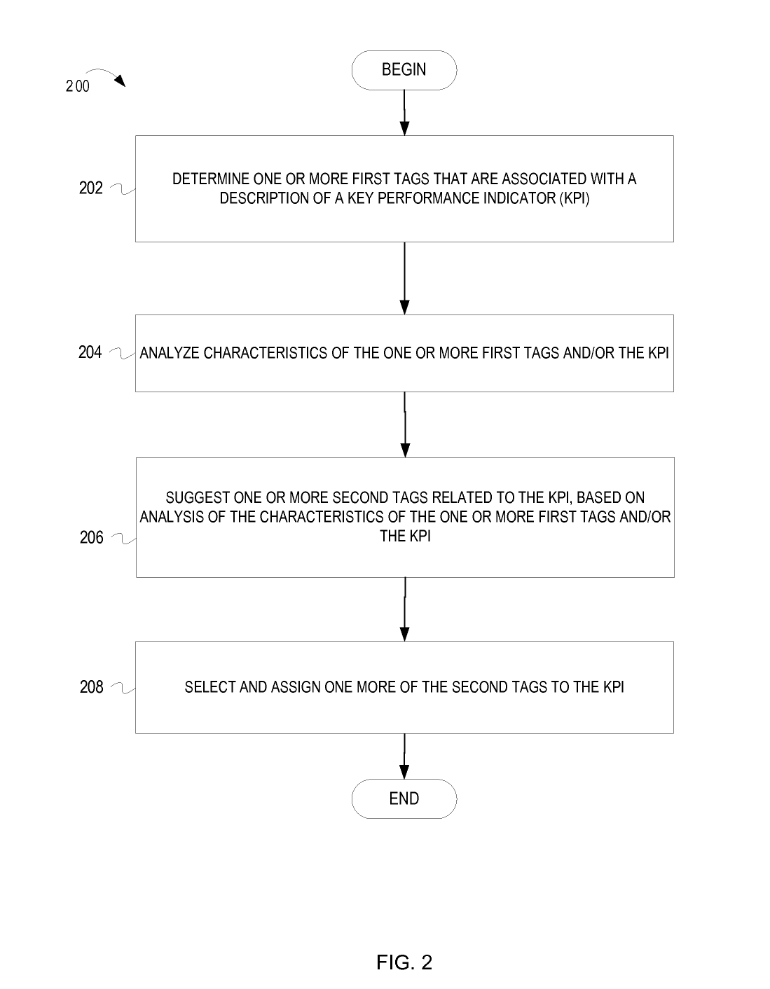

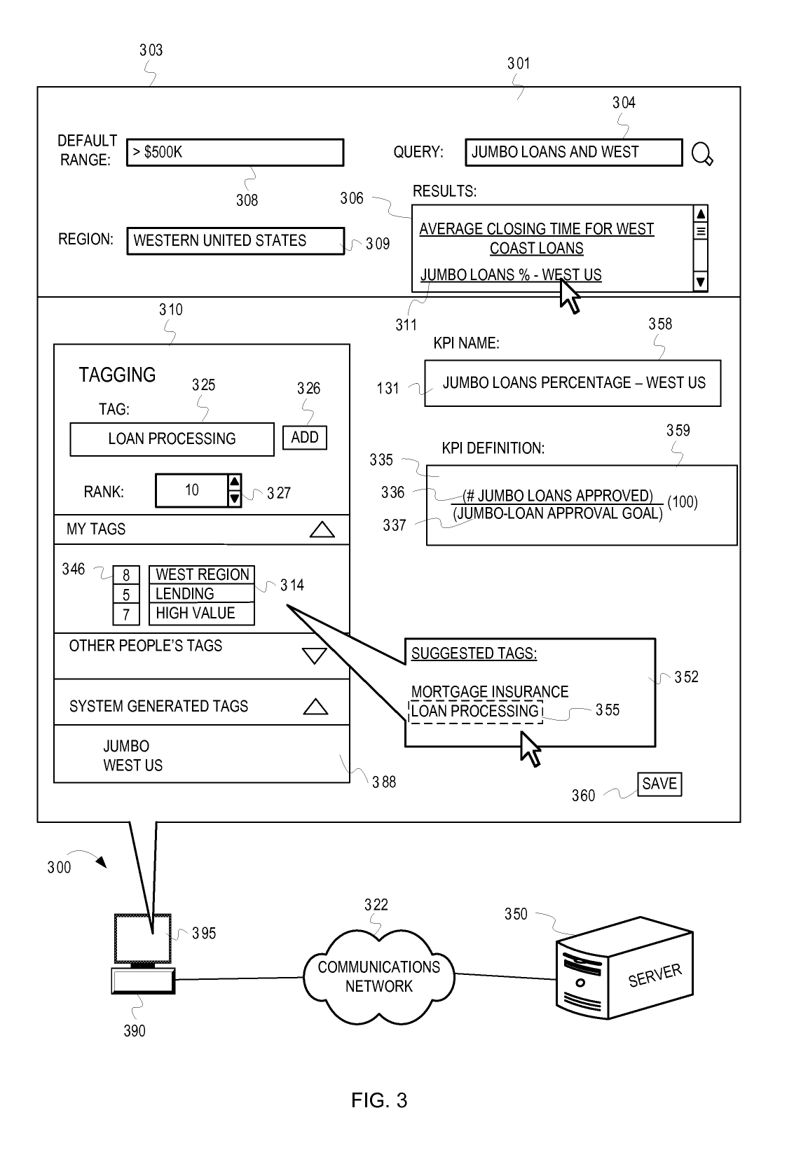

The system 100 compares the business-related information associated with the situation, to information associated with KPIs. The KPIs may be associated with tags that represent categories of KPIs. The tags may have been pre-associated with descriptions of the KPIs via a user-initiated tagging session and/or via dynamic system tagging (e.g., see FIGS. 2 and 3). The business-related information may also have second tags (e.g., bookmark tags, image tags, blog tags, RSS (Really Simple Syndication) tags, etc.) that were pre-associated by content providers. Thus, in some embodiments, the system 100 compares content tags (“first tags”) to the second tags assigned to the KPIs. For instance, the system 100 compares the tags 114 from the news content to tags associated with KPIs (e.g., tags 314 described in FIG. 3 further below, which are associated with KPI 131, “Jumbo Loans %−West US,” prior to the system 100 detecting the receipt of the news content).

Based on the comparison of the business-related information to the information associated with the KPIs, such as via comparison of the first tags to the second tags, the system 100 selects specific ones of the KPIs to present. For instance, the system 100 can first select relevant ones of the second tags that are associated with the first tags (e.g., the system 100 presents relevant tags 125 in a relevant-tags area 120). One of the relevant tags 125 includes the “Loan Processing” tag (“tag”) 121, which was previously associated with the KPI 131 via the user-initiated tagging session and/or via dynamic system tagging described in FIGS. 2 and 3. The system 100 either selects the tag 121 automatically, based on a relevance ranking, or detects that a user selects the tag 121 from the relevant-tags area 120, and in response, the system 100 dynamically modifies content in the KPI presentation area 130, to include KPIs that are associated with the tag 121, such descriptions of the KPI 131 and 191, and performance measurement graphics 132 and 192 that describe a calculation of the KPIs 131 and 191.

The system 100 presents additional tags, such as tags 142 in an additional tag area 140. The user, or other users, may have previously specified the tags 142 as being associated with one or more of the KPIs stored on the system 100 (e.g., in a KPI store on the server 150, in a KPI store on the computer 190, etc.) and/or presented in the KPI presentation area 120. The system 100 can, for instance, detect a manual selection of an additional tag (i.e., tag 141) from the additional tags area 140 and perform a filter of the tag 121 using the additional selected tag 141. The system 100 can also modify the tags 142 to be tags that are related to the tag 141. The system 100 can modify an amount of the tags 142 to display, such as via a user control 143.

In some embodiments, the system 100 presents tags in a way that corresponds to relevance to the situation. For example, in the relevant-tag area 120, the system 100 presents the relevant tags 125 according to font size that is larger for more relevant tags and smaller for less relevant tags. The grouping of the relevant tags 125 appear as a cloud format (e.g., a tag cloud, a data cloud, a text cloud, etc.). The characteristics of the relevance can relate, in some embodiments, to frequency of occurrence of a tag (e.g. a number of times that a tag has been applied, a number of times a tag has been applied to a single item), a quantity (e.g. a quantity of tags in a group, a quantity associated weights or other numerical values, etc.), or other characteristics that indicate a degree. For example, the relevance can be related to assigned weights that the system 100 assigns via a relevance algorithm during comparison of tags. In other embodiments, the relevance can be related to ranks, or weights, that the system 100 detects from user input (e.g., user-indicated rankings 346 described in FIG. 3). The additional tags 140 are also presented in a cloud format with differences in font type and size. Text or other visual representations of tags (e.g., graphics, symbols, etc.) can further vary by other characteristics, such as color, orientation, movement, etc.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable storage media (e.g., software), while in other embodiments, the operations can be performed by hardware and/or other logic (e.g., firmware). Moreover, some embodiments can perform more or less than all the operations shown in any flow diagram.

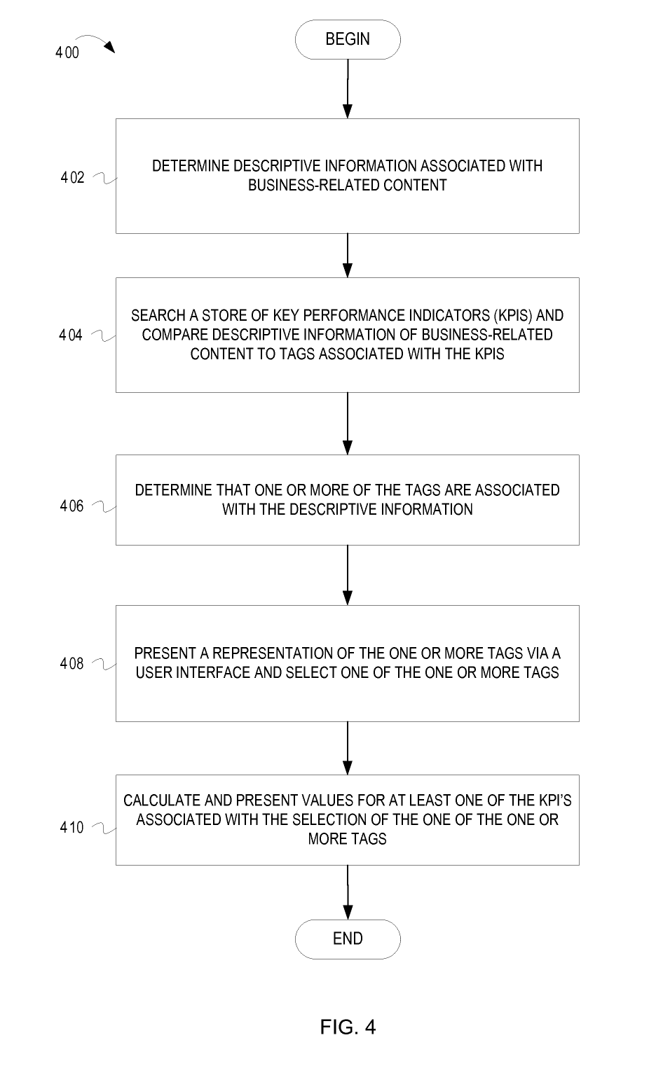

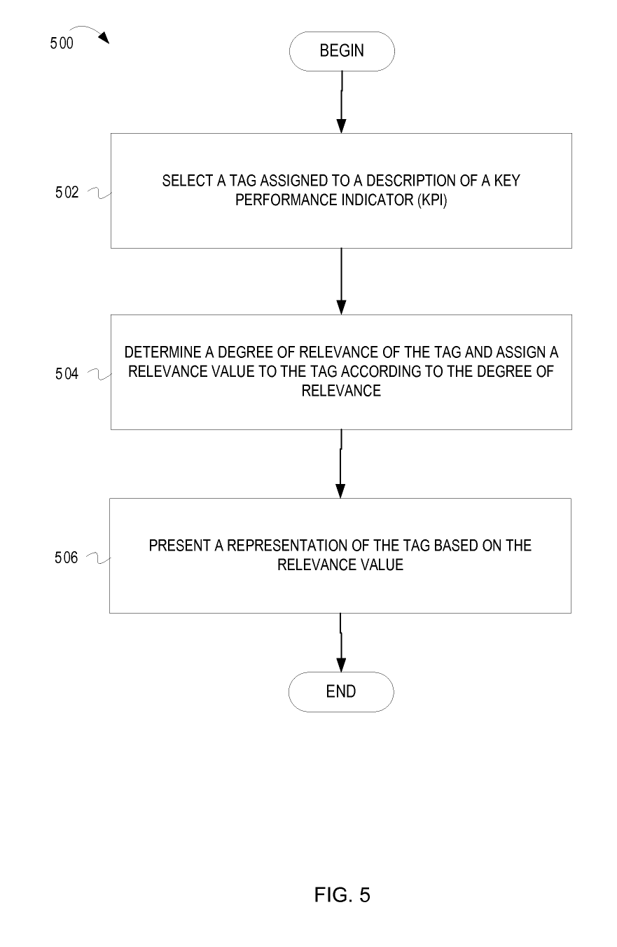

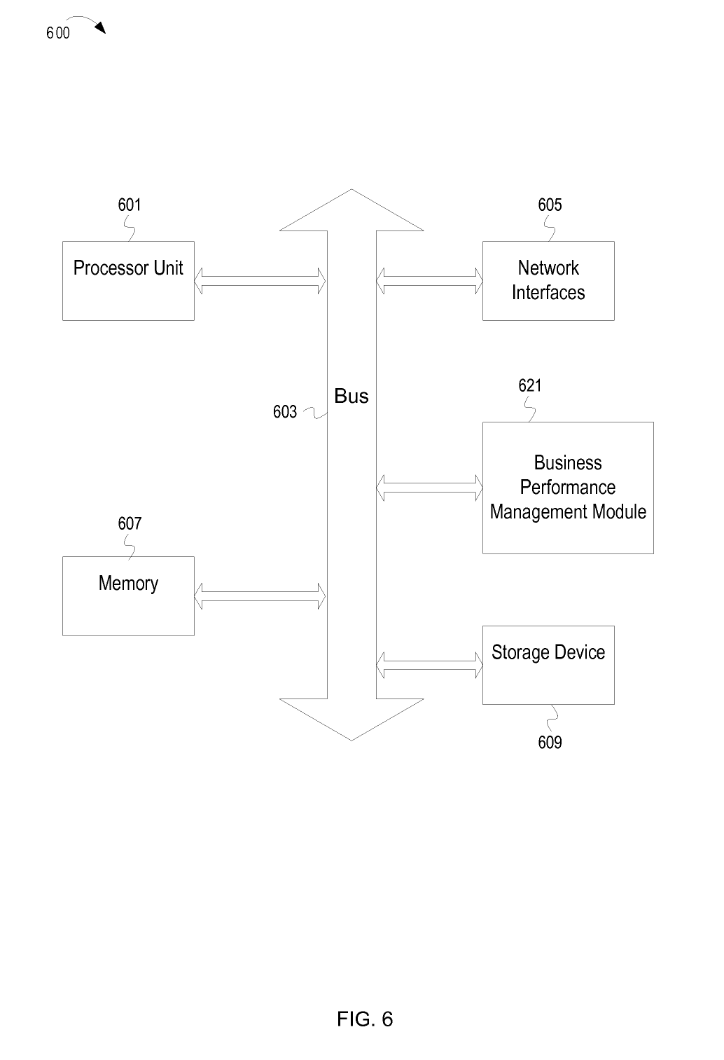

FIG. 2 is a flowchart depicting example operations for assigning and suggesting tags related to KPIs. For example purposes, operations associated with the blocks in FIG. 2 will be described as being performed by a business performance management system (“system”), which may, for example, include any or all of the elements described in FIG. 1, FIG. 3, or FIG. 6. FIG. 2 illustrates a flow 200 that the system can perform. The description of FIG. 2 will also refer to FIGS. 1 and 3. In some embodiments, the flow 200 of FIG. 2 can precede or follow flows described in FIGS. 4 and 5, or can be performed in parallel with the flows of FIGS. 4 and 5. Some or all of the flow 200 of FIG. 2 may be performed separately and independently from the flows of FIGS. 4 and 5.

Referring to FIG. 2, the system determines one or more first tags that are associated with a description of a key performance indicator (KPI) (202). For example, the system can select tags that a user has specified. As an example, FIG. 3 is an illustration of an example business performance management system 300. In FIG. 3, the business performance management system (“system”) 300 includes one or more devices that are connected to each other, such as a computer 390 and a server 350 that are connected by a communications network 322. The computer 390 is configured to receive user input via various input capturing devices, such as a keyboard, a mouse, a microphone, etc. The computer 390 includes a display 395. The display 395 presents user interface (“interface”) 303. The interface 303 presents an area 301 where a user inputs search criteria to search for, and find, existing KPIs stored in a KPI store. For example, the area 301 includes an area 304 where user can input a search query (e.g., using search terms such as “Jumbo Loans” and “West” and a Boolean operator “AND”). The area 301 also includes areas 308 and 309 for entering filtering criteria, such as to specify a value range (e.g., to filter/search for KPIs that are applicable for dollar amounts greater than $500K) or a region (e.g., to filter/search for KPIs that are applicable to the “Western United States”). The search query returns results listed in area 306 which lists names of KPI identifiers that corresponds to the search criteria. In other embodiments, instead of, or in addition to a search query, the system 300 can present a list of tags that exist (e.g. present portions of a tag area 310 that specify existing tags, which, when selected, may present a group of system-generated KPIs that are assigned to that tag value).

When one of the KPI identifiers is selected from the area 306 (e.g., identifier 311 which corresponds to the first KPI 131, “Jumbo Loans Percentage—West US”), the system 300 presents the name of the selected KPI identifier 311 in an area 358. The system 300 also presents an area 359 that includes a KPI definitional value 335 that defines a mathematical or computational description of the KPI 131, such as equations, functions, statements, etc. that. For instance, the KPI definitional value 335 defines the KPI 131 as being a ratio of a first value 336 (i.e., a number of approved jumbo loans) and a second value 337 (i.e., a goal for approved jumbo loans) multiplied by a factor of “100.”

The interface 303 further presents the tag area 310 where a user can input tags associated with the KPI 131. For instance, a user can type text into a text field 325, and can subsequently press a button 326, which then adds the text to a list of tags 314. The tag area 310 can further include a ranking control 327 that a user can utilize to assign ranks or weights to tags based on a perceived degree of importance, according to the user's perspective, to the subject matter and/or category that the tag indicates in relation to the KPI 131 (e.g., adds the value of a rank specified by the ranking control 327 to user-indicated rankings 346).

Referring back to FIG. 2, the system analyzes characteristics of the one or more first tags and/or the KPI (204). For example, the system analyzes semantics, definitional components (e.g., calculations, values, formulas, functions, statements, equations, etc.) or other characteristics of the tags or KPI. For instance, in FIG. 3, the system 300 analyzes any of the characters, words, phrases, symbols, etc. indicated within the interface 303 (e.g., “jumbo,” “loan,” “percentage,” “west,” “US,” “approved,” “$500K,” “region,” “lending,” “high value,” “#” symbol, “$” symbol, “K”, etc.), and based on the meaning of those characters, words, phrases, and/or symbols, the system 300 determines a degree to which one of the characters, words, phrases and/or symbols, or similar characters, words, phrases, or symbols, would potentially make a valuable keyword. The system 300 can translate symbols into textual equivalents depending on the context of the symbol (e.g., translate the symbol “#” to the word “number” or “amount,” translate the symbol “$” to “dollar,” translate the symbol “K” to the word “thousand,” etc.). In other examples, the system utilizes symbols without translating to textual meanings. For example, in some embodiments, the “#” symbol may represent a hash tag that indicates a special meaning within the context of the content, such as when the hash tag is appended to another keyword for recognition as a topic identifier (e.g., for tracking topic trends within social communication applications).

Referring again to FIG. 2, the system suggests one or more second tags related to the KPI, based on the analysis of the characteristics of the one or more first tags and/or the KPI (206). For instance, referring back to FIG. 3, after the system 300 uses the analysis of the semantics, definitional components, etc. of the characters, words, phrases, and/or symbols indicated within the interface 303 to determine potentially valuable keywords, the system 300 suggests the potentially valuable keywords as potential tags 352. The system 300 can further determine whether specific keywords are already input into the system as tags (e.g., if one of the tags 314 is identical to one of the potential tags 352, the system 300 can exclude presentation of such keyword(s) as one of the potential tags 352). In some embodiments, the system 300 can also analyze events that occur within the system 300, such as via business processes, methods, activities, etc. The system 300 analyzes the events and, based on the analysis of the events, generates some of the potential tags 352.

Referring back to FIG. 2, the system selects and assigns one more of the second tags to the KPI (208). For instance, in FIG. 3, the system 300 detects that a user selects potential tag 355 (i.e., the keywords “Loan Processing”) from the potential tags 352, and assigns the potential tag 355 to the KPI 131 (e.g., the system 300 enters the phrase “Loan Processing” into the text field 325, which will then be added to the tags 314 when the button 326 is activated, the system 300 appends the potential tag 355 directly to a system-generated tag section 388, etc.). In another example, instead of the user selecting one of the potential tags 352, the system 300 may automatically, or dynamically, assign one or more of the potential tags 352. For instance, if one of the potential tags 352 has been assigned to another KPI, or other KPIs, that are substantially similar to the KPI 131, the system 300 may determine that the KPI 131 should also be tagged with the one or more of the potential tags 352. As an example, the system 300 determines that business analyst users may have repeatedly and consistently assigned the tag 355 to other KPIs that are similar to KPI 131, thus the system 300 also assigns the tag 355 to the KPI 131 (and the tag 355 would appear in the system-generated tags section 388). In another example, the system 300 determines that the tag 355 is assigned to additional KPIs that are included in the definition of the KPI 131 (e.g., the system 300 determines that the potential tag 355 is already assigned to the first value 336, which may be an additional KPI stored in a KPI stored on the server 350) thus the system 300 also assigns the tag 355 to the KPI 131. The interface 303 also includes a control 360 that can save configurations made via user input and/or the system 300 can automatically save configurations.

FIG. 4 is a flowchart depicting example operations for presenting KPIs based on tag analysis. For example purposes, operations associated with the blocks in FIG. 4 will be described as being performed by a business performance management system (“system”), which may, for example, include any or all of the elements described in FIG. 1, FIG. 3, or FIG. 6. FIG. 4 illustrates a flow 400 that the system can perform. The description of FIG. 4 may also refer to FIGS. 1 and 3. In some embodiments, the flow 400 of FIG. 4 can precede or follow flows described in FIGS. 2 and 5, or can be performed in parallel with the flows of FIGS. 2 and 5. Some or all of the flow 400 of FIG. 4 may be performed separately and independently from the flows of FIGS. 2 and 5.

Referring to FIG. 4, the system determines descriptive information associated with business-related content (402). For example, the system can detect data or metadata associated with the business-related content presented via a user interface, such as in FIG. 1, where the system 100 detects information from various sources of data presented via the interface 103. For instance, the system 100 detects information from one or more of the loan application forms indicated in the loan application section 104 such as types of loans and/or location categories (e.g., loans made in the “North” and “South” Bay areas of the San Francisco, Calif. area). In another example, the system 100 detects an alert from the alerts section 105, which indicates that a prime rate increased recently. The system 100 further receives news content, via the news feed 106, which specifies that a specific lender, “Mighty Mo,” earned an award and that loan costs in the Westerns United states are rising. The system 100 detects data and/or metadata associated with the forms, the alerts, and the news content (e.g., the tags 114). The system 100 further detects, from user information 107, that a logged-in user (“Marcus Miller”) is from the “Lending” department of a business organization.

In other examples, however, the system can determine events, conditions, characteristics, descriptions, and other data, stored on the computer 190 or on the server 150, regarding business-related content that is not presented within the interface 103. For example, the system 100 may detect that a configuration of a KPI changes (e.g. a business analyst user updates or refines a definition of KPI 131, a business analyst user adds a new tag to the KPI 131, etc.). The system 100 can automatically respond to the changes to the KPI configurations even though the configurations are not made or presented via the interface 103. In other examples, the system 300 detects business-related events that occur that are related to business performance, such as events associated with business processes and operations, resource planning, customer relationship management, etc. The server 150, for example, detects the business-related events, via the communications network 122, even though representations of the business-related events are not presented via the interface 103. Based on the business-related events, the system 100 can update tags 125, relevance of tags 125, selection of tags 125, etc., and/or presentation of computational representations of KPIs via the KPI presentation area 130.

Referring again to FIG. 4, the system searches a store of KPIs and compares the descriptive information of the business-related content to tags associated with the KPIs (404). For example, in FIG. 1, the system 100 uses all of the descriptive information that the system 100 gathered from the forms, alerts, and news content, and the system 100 compares the descriptive information to tags associated with KPIs stored in the system 100 (such as KPIs stored on the server 150 and/or on the computer 190), as described previously.

Referring again to FIG. 4, the system determines that one or more of the tags are associated with the descriptive information (406). For instance, as described previously in FIG. 1, the system 100 compares the tags that represent categories of KPIs (e.g., the tags 314 or 388 indicated in FIG. 3) and the descriptive information of the business-related content (e.g., the data, metadata, tags, etc. associated with the forms, alerts, news content, etc. shown in FIG. 1). The system 100, for example, can use semantic similarity or exploit taxonomy among the tags, to search for tags, compare tags, etc.

Referring back to FIG. 4, the system presents a representation of the one or more tags via the interface and selects one of the one or more tags (408). The system then calculates and presents values for at least one of the KPIs associated with the selection of the one of the one or more tags (410).

For example, as described in FIG. 1, the system 100 determined that tags 125 were relevant to all of the descriptive information of the business-related content and presented tags 125 within the relevant-tags area 120. For instance, because of the geographic location information of the forms indicated in the loan application section 104 (i.e., the “North Bay” and “South Bay” data), geographic location information indicated in one of the titles 112 (i.e., the “San Francisco” information), a location-related phrase from one of the summaries 113 (i.e., “Western United States”), and one of the tags 114 (i.e., “West”) which specifies geographic location, the system 100 determines that appropriate tags, stored within a tag store stored in the system 100, may be the keywords “Loan Processing,” “West Coast,” and “California” which are associated with tags in the tag store. The system 100, thus, presents the relevant tags 125, which include “Loan Processing,” “West Coast,” and “California.” Further, the system 100 can detect that a user selects one of the tags 121, which includes the keywords “Loan Processing.” As a result, the system 100 searches through all KPIs that include the keyword “Loan Processing” and or other relevant words associated with others of the relevant tags 125, and calculates a ranking of the KPIs. The system 100 then determines that the two highest ranked KPIs (e.g., KPIs 131 and 191) should be displayed in the KPI presentation area 130. In some embodiments, the system 100 can utilize a Representation State Transfer (REST) service to return a list of KPIs (e.g., KPIs 131 and 191). The system 100 then performs calculations for the KPIs 131 and 191, according to definitions of the KPIs 131 and 191 (e.g., formula, statements, equations, etc.), to generate the performance measurement graphics 132 and 192 associated with computed values for the KPIs 131 and 191.

Further, the system 100 can automatically select the tag 121 based on a degree of relevance. For example, the system 100 can measure a degree of relevance of all of the relevant tags 125 (e.g., determine a frequency that the relevant tags 125 are assigned to the KPI's within the KPI store). The tag with the highest ranking relevance value (e.g., tag 121) may be automatically selected by default. The system 100 can also provide a control 123 that the user can select to toggle automatic selection of tags.

The system 100 may also include relevant tags “ARMs” (Adjustable Rate Mortgages) and “Rates” because of the phrase “Prime Rate” in the alerts section 105. Other relevant tags include “Mortgage,” “Business,” “Credit,” and other types of tags that are stored in the tags store of the system 100. In some embodiments, the system 100 can further provide controls 124, 125 and 126 which, when selected, will indicate to the system 100 to analyze content for the area of the interface 103 to which the controls 124, 125, and 126 are assigned. For instance, if the user wants tags 125 or tags 142 to show only for a specific type of content, such as news items, then the user can select control 126 only, and deselect controls 124 and 125. In other embodiments, the system 100 can provide advanced settings (e.g., via selection of control 128) through which various types of content can be configured. For instance, the advanced settings can further specify (e.g., via filters, search queries, etc.) specific types, or categories, of news content for which to dynamically update KPIs. For example, a user can specify only competitive news types, only news that is tagged, only news that is about real-estate, etc., which distinguishes various subject matters, tagged v. non-tagged content, etc.

Further, the system 100 can automatically update presentation of KPIs (e.g., automatically update a list of KPIs, automatically recalculate the existing KPIs, etc.) dynamically based on changes to content and/or context of content presented within the interface 103. For instance, if the news content changes within the news feed 106, the system 100 can automatically reevaluate tags, automatically reevaluate tag relevance, automatically change tags 125 and/or 124, automatically select tags, automatically reconfigure the appearance of the KPI presentation area 130 with KPIs that are most relevant for selected tags, etc.

Further, the system 100 can assign tags based on analysis. For instance, the system 100 can, via the analysis of tags, determine that one of the tags 114 is substantially similar in meaning to tags associated with the KPIs 131 and 191, however the KPIs 131 and 191 do not have a tag assigned with the exact keyword as the one of the tags 114. The system 100, therefore, can dynamically assign the one of the tags 114 to the KPIs 131 and/or 191.

FIG. 5 is a flowchart depicting example operations for presenting KPI tags according to relevance. For example purposes, operations associated with the blocks in FIG. 5 will be described as being performed by a business performance management system (“system”), which may, for example, include any or all of the elements described in FIG. 1, FIG. 3, or FIG. 6. FIG. 5 illustrates a flow 500 that the system can perform. The description of FIG. 5 may also refer to FIGS. 1 and 3. In some embodiments, the flow 500 of FIG. 5 can precede or follow flows described in FIGS. 2 and 4, or can be performed in parallel with the flows of FIGS. 2 and 4. Some or all of the flow 500 of FIG. 5 may be performed separately and independently from the flows of FIGS. 2 and 4.

Referring to FIG. 5, the system selects a tag assigned to a description of a key performance indicator (KPI) (502). The system determines a degree of relevance of the tag and assigns a relevance value to the tag according to the degree of relevance (504). Further, the system presents a representation of the tag based on the relevance value (506).

For example, in some embodiments, as described for processing block 406 in FIG. 4, the system analyzes descriptive information (e.g., from the interface 103 in FIG. 1) to determine relevance of various portions of the descriptive information and to prioritize, rank, or rate the various portions. Based on the priority, rank, or rating, the system can present characteristics of the relevant tags in ways that express the degrees of relevance (e.g., font size or type indicates the priority, rank, or rate) for relevant tags, as described in FIG. 1.

In another example, as described at processing block 206 in FIG. 2, the system receives weights, or ranks, assigned by user input. The system can use the weights or ranks to further compute a relevance value for tags.

### Additional Example Embodiments

According to some embodiments, a business performance management system (“system”) can provide various example devices, operations, etc., to dynamically monitor and present business performance indicators according to business situations. The following non-exhaustive list enumerates some possible embodiments.

In some embodiments, the system can detect news items related to a region, and update (e.g., update list of KPIs, update a calculation of KPIs, etc.) KPIs that are tagged with the name of the region (e.g. a warranty process cost in a “north east” region).

In some embodiments, the system can detect a competitive pricing alert, such as when an auto manufacturer receives an alert of a price change to a vehicle model. The business performance management system can update KPIs related to sales, stock levels, etc. associated with the vehicle model and for similar vehicle models.

In some embodiments, the system determines organizational and user context, such as a user's organization or department, or a currently viewed organization or department. The system can further track a user's profile information for tags (e.g., stored in a tag inventory) or other descriptive information (e.g., user's role, user's subordinates, user's work history, etc.). The system can update KPIs which are relevant to the organizational and/or user context.

In some embodiments, the system determines business processes, such as when a user has been working in, or looking at, an order fulfillment application, and updates KPIs accordingly.

In some embodiments, the system tracks a state of business performance measured against targets (such as via a scorecard) and update KPIs accordingly. The system can determine trends of key performance indicators (e.g., revenue, cost, response time, etc.). For instance, the system can track market share growth and new product revenue.

In some embodiments, the system tracks business process monitoring (per instance), such as status of a particular insurance claim or response time/execution time limit exceeded for a task, and updates KPIs accordingly.

In some embodiments, the system determines business process statistics (in aggregate), such as average durations, costs, branch ratios, etc., and updates KPIs accordingly.

In some embodiments, the system tracks alerts of events that require action, such as alerts regarding revenue drop, inventory shortage, time/cost increases, competitor price changes, etc., and updates KPIs accordingly.

In some embodiments, the system manages responses to critical business situations, and updates KPIs accordingly, such as finding a new supplier when a high value order arrives while out of inventor and an existing supplier is decommitted.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in one or more computer readable medium(s) having computer readable program code embodied in the medium.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto, or stored on, an electronic device (e.g., computer, cell phone, television, set-top box, etc.) to function in a particular manner, such that the instructions cause a series of operational steps to be performed to produce a computer implemented process such that the instructions which execute on the electronic device provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 6 depicts an example computer system 600. The computer system 600 includes a processor unit 601 (possibly including multiple processors, multiple cores, multiple nodes, and/or implementing multi-threading, etc.). The computer system 600 includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media or computer readable storage media. The computer system 600 also includes a bus 603 (e.g., PCI bus, ISA, PCI-Express bus, HyperTransport® bus, InfiniBand® bus, NuBus bus, etc.), a network interface 605 (e.g., an ATM interface, an Ethernet interface, a Frame Relay interface, SONET interface, wireless interface, etc.), and a storage device(s) 609 (e.g., optical storage, magnetic storage, etc.). The computer system 600 also includes a business performance management module 621. The business performance management module 621 can dynamically update presentation of performance indicators. Any one of these functionalities may be partially (or entirely) implemented in hardware and/or on the processing unit 601. For example, the functionality may be implemented with an application specific integrated circuit, in logic implemented in the processing unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601, the storage device(s) 609, and the network interface 605 are coupled to the bus 603. Although illustrated as being coupled to the bus 603, the memory 607 may be coupled to the processor unit 601.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

In some embodiments, the method as described above can be used in the fabrication of integrated circuit chips.

While the embodiments are described with reference to various implementations and exploitations, it will be understood that these embodiments are illustrative and that the scope of the inventive subject matter is not limited to them. In general, techniques for dynamically updating performance indicators as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
detecting an event associated with business-related content;
evaluating the business-related content against a plurality of tags associated with a plurality of key performance indicators responsive to said detecting the event associated with the business-related content;
determining that a set of the plurality of tags corresponds to the business-related content based, at least in part, on said evaluating the business-related content against the plurality of tags;
selecting a set of the plurality of key performance indicators associated with the set of the plurality of tags; and
presenting computational representations of the set of the plurality of key performance indicators via a user interface responsive to said selecting the set of the plurality of key performance indicators.

2. The method of claim 1, wherein the business-related content comprises additional tags, wherein said evaluating the business-related content against the plurality of tags associated with the key performance indicators comprises comparing first words included in the additional tags to second words included in the plurality of tags, and wherein said determining that the first set of the plurality of tags correspond to the business-related content comprises determining a degree of similarity between meanings of the first words and the second words.

3. The method of claim 1, wherein said evaluating the business-related content against the plurality of tags associated with the key performance indicators comprises:
determining a degree of relevance of each of the set of the plurality of tags; and
presenting, via the user interface, the set of the plurality of tags to visually depict the degree of relevance for the each of the set of the plurality of tags.

4. The method of claim 3, wherein presenting the set of the plurality of tags to visually depict the degree of relevance comprises modifying textual characteristics of the set of the plurality of tags based on the degrees of relevance.

5. The method of claim 3, wherein said determining the degree of relevance of each of the set of the plurality of tags comprises:
computing a relevance value for the each of the set of the plurality of tags based on determining a frequency that the each of the set of the plurality of tags is assigned to the plurality of the key performance indicators.

6. The method of claim 3 further comprising:
determining that one of the set of the plurality of tags has a highest relevance value;
selecting the one of the set of the plurality of tags; and
filtering the set of the plurality of key performance indicators to correspond to only the one of the set of the plurality of tags

7. The method of claim 1, wherein said detecting the event comprises detecting one or more of a change to a business metric value related to an aspect of business performance, an occurrence of a business process related to an aspect of business performance, receipt of a news feed item via a news feed application, and a login of a user account.

8. A computer program product for dynamically updating presentation of key performance indicators, the computer program product comprising:
a computer readable storage medium having computer readable program code embodied therewith, the computer readable program code comprising:
computer readable program code configured to,
detect an event related to content used to generate a business performance metric, wherein the content includes a first tag,
compare the first tag to a plurality of tags assigned to a plurality of key performance indicators,
determine a portion of the plurality of tags that are substantially similar in meaning to the first tag in response to said comparison of the first tag to the plurality of tags, and
present computational representations of only a portion of the plurality of key performance indicators that are assigned to the portion of the plurality of tags.

9. The computer program product of claim 8, wherein the computer readable program code is further configured to,
present the portion of the plurality of tags in a tag cloud,
select a second tag, in response to user input, from the portion of the plurality of second tags, and
filter said computational representations using the second tag.

10. The computer program product of claim 8, wherein the computer readable program code is further configured to,
rank the portion of the plurality of the tags according to relevance,
select a second tag from the portion of the plurality of tags according to the rank, and
filter the computational representations using the second tag.

11. The computer program product of claim 8, wherein the computer readable program code is further configured to,
present the plurality of tags with characteristics proportional to the degrees of relevance.

12. The computer program product of claim 11, wherein the characteristics comprise one or more of size, shape, color, action, and orientation of the plurality of tags.

13. The computer program product of claim 8, wherein the computer readable program code is further configured to,
determine an organizational role associated with a user account, wherein the user account is associated with a computer session during which the computational representations are presented via a user interface, and
filter one or more of the portion of the plurality of tags and the portion of the plurality of key performance indicators based on the organizational role.

14. The computer program product of claim 8, wherein the plurality of tags comprise one or more of a bookmark tag, an image tag, a blog tag, and a Really Simple Syndication feed tag.

15. An apparatus comprising:
a processing unit;
a network interface; and
a business performance management module operable to,
select one or more first tags that are associated with a description of a business performance indicator,
analyze characteristics of the one or more first tags,
suggest one or more second tags related to the business performance indicator based on analysis of the characteristics of the one or more first tags,
select at least one of the one or more second tags, in response to user input, and
assign the at least one of the one or more second tags to the business performance indicator.

16. The apparatus of claim 15 wherein the business performance management module is further operable to analyze the characteristics of the one or more first tags being operable to
detect occurrence of one or more events related to the one or more first tags, and
determine that one or more first descriptions associated with the one or more events are related to one or more second descriptions related to the one or more second tags.

17. The apparatus of claim 15 wherein the business performance management module is further operable to
detect one or more weight values assigned to the one or more first tags, wherein the one or more weight values specify user preferences for the one or more first tags, and
suggest the one or more second tags based on the one or more weight values.

18. The apparatus of claim 15 wherein the business performance management module is further operable to,
determine that an additional business performance indicator is specified in a definition for the business performance indicator, wherein at least a portion of the one or more second tags are associated with the additional business performance indicator,
compare descriptive data of the one or more first tags to the at least a portion of the one or more second tags associated with the additional business performance indicator; and
suggest the at least a portion of the one or more second tags.

19. The apparatus of claim 15 wherein the business performance management module is further operable to,
determine that an additional business performance indicator is specified in a definition for the business performance indicator, wherein one or more third tags are associated with the additional business performance indicator, and
suggest the one or more third tags.

20. The apparatus of claim 15 wherein the business performance management module is further operable to,
receive a plurality of news feed items,
select one of the plurality of news feed items, wherein one or more third tags are assigned to the one of the plurality of news feed items,
compare the one or more third tags to one or more of the one or more first tags and the one or more second tags assigned to the business performance indicator,
select the business performance indicator based on a comparison of the one or more third tags to one or more of the one or more first tags and the one or more second tags assigned to the business performance indicator, and
present computational data for the business performance indicator in response to selection of the business performance indicator being based on the comparison of the one or more third tags to the one or more of the one or more first tags and the one or more second tags assigned to the business performance indicator.
